(19) United States
(12) Patent Application Publication
(10) Pub. No.: US 2020/0256312 A1
(43) Pub. Date: Aug. 13, 2020

(54) Method of Manufacture and the Resulting Vertical Axis Wind Turbine Airfoil

(71) Applicant: Arthur David Stanton, Garland, TX (US)

(72) Inventor: Arthur David Stanton, Garland, TX (US)

(21) Appl. No.: 16/271,843

(22) Filed: Feb. 10, 2019

(51) Int. Cl. F03D 3/06; F03D 3/00

(52) U.S. Cl. CPC F03D 3/062; F03D 3/005; F05B 2230/60; F05B 2280/4002; F05B 2230/90; F05B 2240/211; F05B 2280/6003; F05B 2230/20

(57) ABSTRACT

A Method of Manufacture for a Vertical Axis Wind Turbine Airfoil by injecting high-density foam into a light-weight air-foil framed-structure assembled by predefined snap-together glue-less components. For alignment, and proper inner frame component positioning the assembly of the framed-structure components is assisted by a table holding in place the frame's forward and aft spar. The internal cross member rib locking-supports have circular-dove-tail-locking snap-together ends. A plurality of the internal light-weight wooden component members is laminated with 0.020″ to 0.040″ aluminum. The assembled frame structure is placed between non-stick sheets within a custom mold which is then clamped down upon the framed structure and injected with high-density foam. The high-density injected frame structure is then carbon fiber resin infused in a vacuum bagged processed.

### FIELD OF THE INVENTION

This invention relates to a method of manufacture for a Vertical Axis Wind Turbine Airfoil and the resulting Vertical Axis Wind Turbine produced.

### BENEFITS OF THE METHOD OF MANUFACTURE AND RESULTING APPARATUS OF INVENTION

1) The benefit of using circular-dove-tail-locking snap together mechanisms, or similar pressure snapping together components facilitates the speed of assembly and construction without the need for glue, nails, screws or other fittings. Moreover, the use of circular-dove-tail-locking snap together mechanisms allows less resistance when snapping the pieces together as in standard dovetail with have sharper edges and are more prone to crack when being pressed together. This weakens the structure with more stress points put in play on the construction and assembly of the components.
2) The benefit of using the aluminum laminated 5 ply Baltic Birch creates extra strength without increasing the weight of the turbine allowing less energy to turn the turbine.
3) Because of the dove-tail-locking snap together mechanisms, combined with impregnating the air frame with high density foam allows the foam to deeply penetrate the pores of the wood and further cinching and bonding the snap-together components providing more additional strength. A reason for this extra strength is because when the foam is impregnated its volume expands 10 times thereby forcing extra pressure into the any voids, cracks or crevices.
4) The benefit of impregnating the air frame with high density foam allows for easier shaping of the wing and decreases the set-time to about 2 hours as opposed to 24 hours for fiberglass.

### SUMMARY OF THE INVENTION

The inventor has both a Method of Manufacture for a Vertical Axis Wind Turbine Airfoil and the resulting Airfoil to be used on a Vertical Axis Wind Turbine.

The Method of Manufacture for a Vertical Axis Wind Turbine Airfoil injects high-density foam into a light-weight air-foil framed-structure assembled by predefined snap-together glue-less components. For alignment, and proper inner frame component positioning the assembly of the framed-structure components is assisted by a table holding in place the frame's forward and aft spar (number 2). The internal cross member rib locking-supports have circular-dove-tail-locking snap-together ends.

A plurality of the internal light-weight wooden component members are laminated with 0.020″ to 0.040″ aluminum. The assembled frame structure is placed between non-stick sheets within a custom mold which is then clamped down upon the framed structure and injected with high-density foam.

The high-density injected frame structure is then carbon fiber resin infused in a vacuum bagged process. Within the process the components are made out of Baltic Birch 5-layer plywood laminated with 0.040 aluminum on the top and bottom side; see (number 31). This type of top and bottom 0.040 aluminum lamination adds a strength factor of more than 500% more than without it. Further, because the lamination is done with 0.040 aluminum this huge strength increase is obtained by adding very little additional weight to the components.

General Description and Description of Component Parts

### Process Steps:

Step 1 is to laminated Baltic Birch 5-layer plywood (number 33) with 0.040″ aluminum on the top and bottom side.

Step 2 the Vertical Axis Wind Turbine Airfoil Internal Component Foil Structure Pieces will be cutout of the previously 0.040 laminated Baltic Birch 5-layer plywood (number 31).

Step 3 Align and slide the laminated ribs (number 1) on the two identical Alignment Laminated Support Struts (number 4) sliding into the Forward Laminated Support Rib Holes (number 11), and Trailing Laminated Support Rib Holes (number 18).

Step 4. Next the unit consisting of the assembled Laminated Ribs and Alignment Laminated Support Struts from Step 3 will be placed in a horizontal and parallel position to the Assembly Alignment Table (number 44) and the Alignment Laminated Support Struts of the said assembled unit will attached or lay upon the Attachment Member (number 45) of the Assembly Alignment Table (number 44).

Step 5. The Leading-Edge Strut (number 2) is snapped by pressure fitted into the plurality the Leading-Edge Rib Notches (number 10) on each of the Laminated Ribs (number 1).

Step 6. The Vertical Struct Notches (number 22) of the Vertical Struts (number 3) are snapped by pressure fitness into place within the Laminated Rib Notches (number 15).

Step 7. The Trailing-Edge Laminated Support Struts (number 7) are then snapped into the Trailing-Edge Rib Notches (number 21).

Step 8. The Leading-Edge Laminated Support Struts (number 2) are then snapped into the Leading-Edge Rib Notches (number 10).

Step 9. The plurality of Circular Dove Tail Male Connectors (number 17) of the plurality of strut locks (numbers 5, 23,24,25, and 26) are snapped into Vertical Strut Female Connector (number 16) of the Vertical Struts (number 3).

Step 10. The assembly of Step 9 is placed onto a Bottom Protective Teflon Sheet (number 37) which is all set on top of the Base Mold Form (number 36). The Base Mold Form (number 36) is setup and attached by the Aluminum External Mold Supports (number 40) to Mold Support Table (number 35).

Step 11. A Top Protective Teflon Sheet (number 38) is now placed upon the top of the assembled components in Step 10.

Step 12. The Top Mold Form (number 39) is now closed using Hinge (number 43) and is latched and Mold Latching Member (number 41) upon the top of the assembled components from Step 11.

Step 13. High density internal wing foam (number 8) is injected into the cavities of the internal component parts within the mold.

Step 14. Upon the foam curing then completely assembled internal components which are now one bonded unit of fold are remove from the mold and the Teflon sheet is pealed away from the air foil.

Step 15 Air foil is lastly covered with a top coat of carbon fibor.

The foregoing and other objects, features, and advantages of the invention will become more apparent from the following detailed description, which proceeds with reference to the accompanying figures wherein the scale depicted is approximate.

The advantages described herein will be more fully understood by reading an example of an embodiment in which the invention is used to advantage, referred to herein as the Detailed

Description with Reference to the Drawings Wherein:

The Alignment Laminated Support Strut (FIG. 4) consists of a thin walled steel or aluminum tube (FIG. 4) injected with high density foam. Vertical Interlocking laminated Baltic-Birch interior laminate (number 29) and Horizontal Interlocking laminated Baltic Birch interior laminate (number 30) components are used. The process begins with the assembly of

Vertical Interlocking laminated Baltic Birch interior components and Horizontal Interlocking laminated Baltic Birch interior laminate component (FIG. 30). These two parts will slide together with a press fit requiring no glue or fasteners. The assembly is then slid inside the thin walled steel or aluminum tube (FIG. 4). Once firmly in place high density foam is injected and allowed to expand inside the thin walled steel or aluminum tube (FIG. 4). As the high-density foams expands, all crevices, cracks, joints and any voids will be permeated with the foam. The foam has superior adhesive characters which will bond all components tightly together. This process will greatly add strength to the thinned wall steel or aluminum tube without adding a lot of weight.

The Alignment laminated support strut (FIG. 4) will now be aligned parallel using the Assembly support table (number 44). Each Alignment laminated support strut (FIG. 4) will lay a top of the Alignment clamp (number 45). The Laminated Ribs (number 1) will now be slid on to the Alignment laminated support struts (FIG. 4) and will be spaced evenly between each other laminated rib. The Vertical struts (number 3) will be pressed into place into each Laminated Rib notch (number 15).

If the struts need to be longer to span the wing width, then splices will be made using the Strut Double T Splice number 6). The connection is very tight and does not require any glue or screws for assembly. This will lower costs and also shorten assembly time since there will be no delay in waiting for time to dry. To hold Vertical struts (number 3) in place and tight, each Vertical strut notch (number 16) will receive a Position one Internal locking circular dove tail support (number 23) base on the size required since the air foil does not have a parallel side.

Position one Internal locking circular dove tail support (number 23) is larger and will be located at the front of the airfoil where it is the thickest. Position two Internal locking circular dove tail support (number 24) is slightly smaller and will be located in the next position. Position three Internal locking circular dove tail support (number 25) is slightly smaller and will be located in the next position. Position four Internal locking circular dove tail support (number 5) is slightly smaller and will be located in the next position. Position five [0030] Internal locking circular dove tail support (number 26) is slightly smaller and will be located in the next and last position. The molding unit which consists of Base mold form (number 36) and Top Mold Form (number 39) are tightly held together by the Locking assembly screw (number 42). The structure is attached to a Mold support table (number 35). The mold unit is further stabilized and supported by the use of Aluminum External Mold Supports (number 40). Upon completion of assembly by snapping together the frame components, the unit is then placed on the Base mold form (number 36) and then sandwiched between the frame and the Base mold form (number 36) is the Bottom Protective Teflon Sheet (number 37). High Density Foam is now injected in and among the individual rib's compartments and a Top Protective Teflon Sheet (number 38) is laid on top of the frame consisting of a group of Laminated Ribs (Figure [0031] 1). Top Mold Form (number 39) is now closed which is assisted by the use of Mold Rear Hinge (number 43) then latched tightly shut with the use of Mold Front Latch (number 41). The high-density foam will flow between all the ribs using the Forward Laminated Rib cutaway (number 12), and Forward Laminated Rib cutaway (number 13), Aft Laminated Rib cutaway (number 14), Middle high-density expanding foam portal entry (FIG. 19) and Trailing high-density expanding foam portal entry (FIG. 20). The High-Density Foam will penetrate the surface pores of the Baltic Birch and Aluminum and permeate thru all joints, cracks and voids bonding the structure together tightly and permanently.

### BRIEF DESCRIPTION OF THE DRAWING FIGURES

FIG. 1 is an illustrative view of the cut-away of the top of the assembled Vertical Axis Wind Turbine Airfoil components.

FIG. 2 is an illustrative view of the interconnection of the laminated ribs, vertical struts, and vertical strut locks.

FIG. 3 is an illustrative view of the of vertical strut locks.

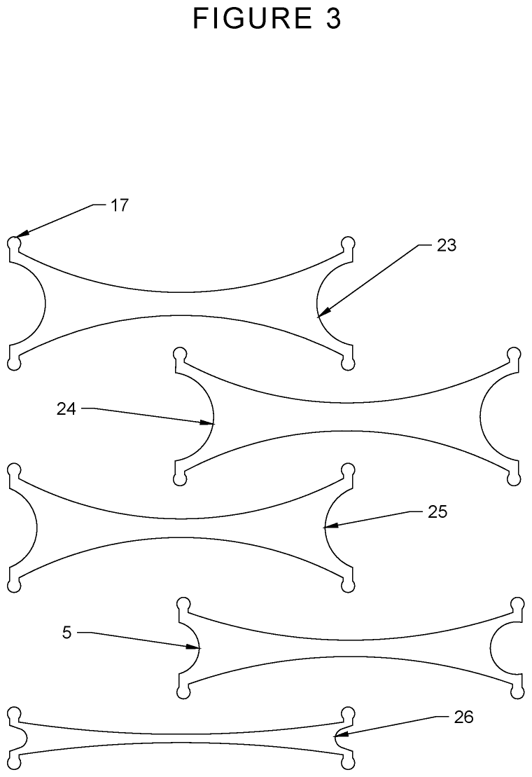

FIG. 4 is an illustrative view of the double-T locking mechanized of the Alignment Laminated Support Strut and the Double Tee Struct Splice

FIG. 5 is an illustrative view of interconnection of the Baltic Birch 5-layer plywood, Top Aluminum Lamination, and the Baltic Birch 5-layer plywood.

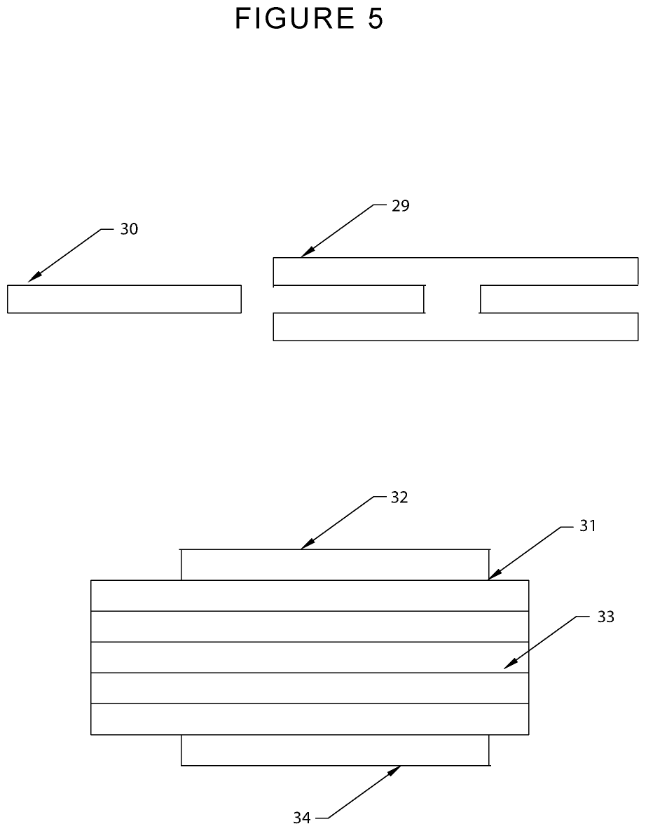

FIG. 6 is an illustrative view of the Mold support table, Base Mold Form, and associated components.

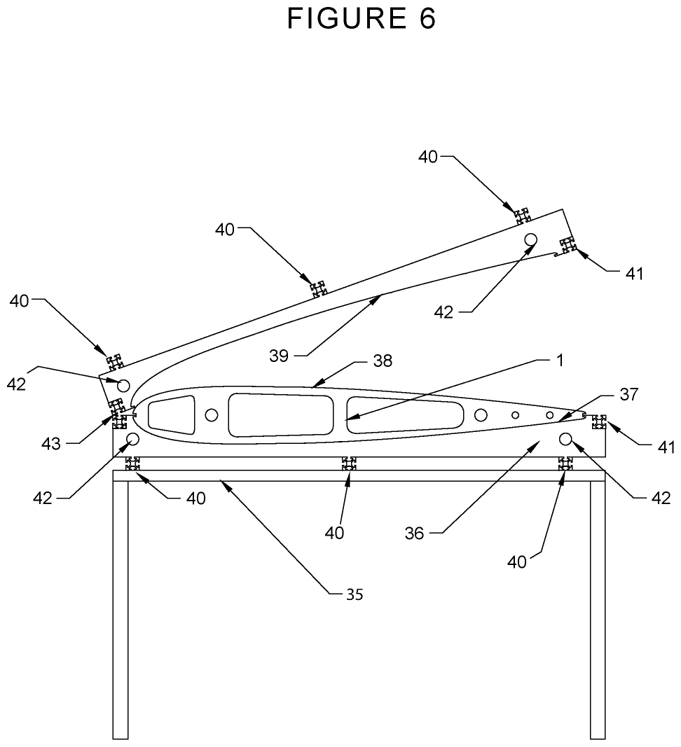

FIG. 7 is an illustrative view of the Assembly Alignment Table.

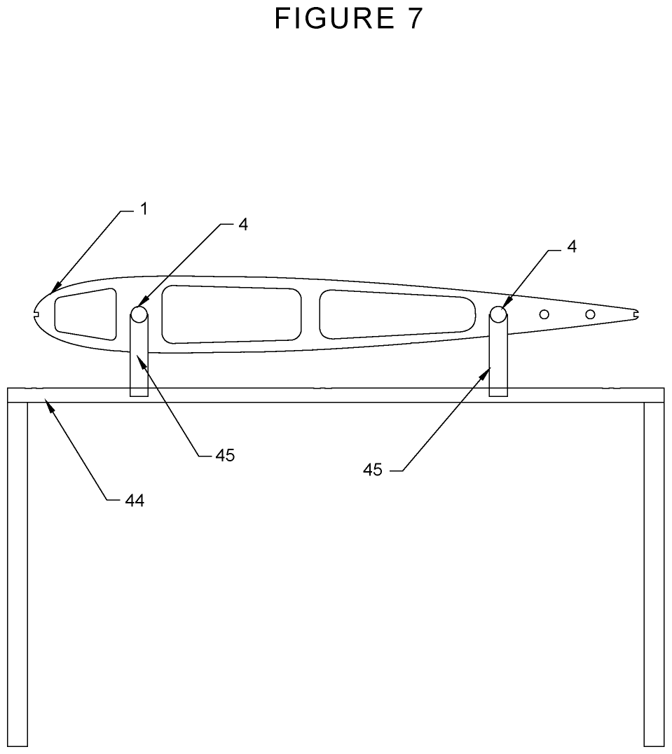

### DESCRIPTION OF THE REFERENCED NUMBERS

Turning now descriptively to the drawings, in which similar reference in characters denote the similar elements throughout the several views, the figures illustrate a method of manufacture for a vertical axis wind turbine airfoil and the resulting vertical axis wind turbine airfoil. With regard to the reference numerals used, the following numbering is used throughout the various drawing's figures:
1. Laminated Rib
2. Leading-Edge Laminated Support Strut
3. Vertical strut
4. Alignment Laminated Support Strut
5. Position four vertical strut lock
6. Double Tee Struct Splice
7. Trailing-Edge Laminated Support Strut
8. High density internal wing foam
9. External layer of carbon fiber
10. Leading-Edge Rib Notch
11. Forward Laminated Support Rib Hole
12. Forward Laminated Rib cutaway
13. Forward Laminated Rib cutaway
14. Aft Laminated Rib cutaway
15. Laminated Rib notch—to receive vertical strut
16. Vertical Strut Female Connector
17. Circular Dove Tail Male Connector
18. Trailing Laminated support Rib Hole
19. Middle high-density expanding foam portal entry
20. Trailing high-density expanding foam portal entry
21. Trailing-Edge Rib Notch
22. Vertical strut notch 23 Position one vertical strut lock
24. Position two vertical strut lock
25. Position three vertical strut lock
26. Position five vertical strut lock
27. Steel tubing
28. High density expanding foam
29. Vertical Interlocking laminated Baltic Birch interior laminate
30. Horizontal Interlocking laminated Baltic Birch interior laminate
31. Baltic Birch 5-layer plywood Laminated
32. Top Aluminum Lamination
33. Baltic Birch 5-layer plywood
34. Bottom Aluminum Lamination
35. Mold support table
36. Base Mold Form
37. Bottom Protective Teflon Sheet
38. Top Protective Teflon Sheet
39. Top Mold Form
40. Aluminum External Mold Support
41. Mold Latching Member
42. Locking assembly screw
43. Mold Rear Hinge
44. Assembly Alignment Table
45. Attachment Member of the Assembly Alignment Table

### Definitions

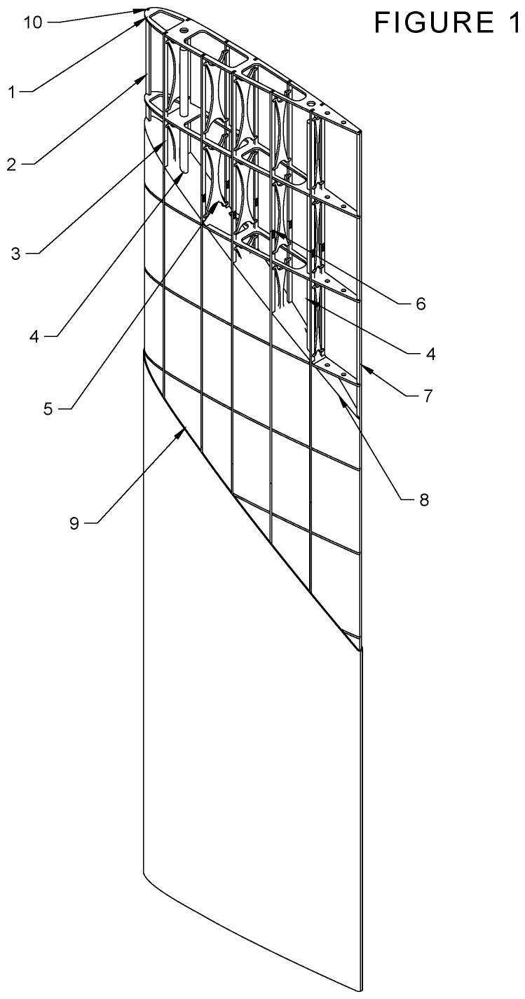

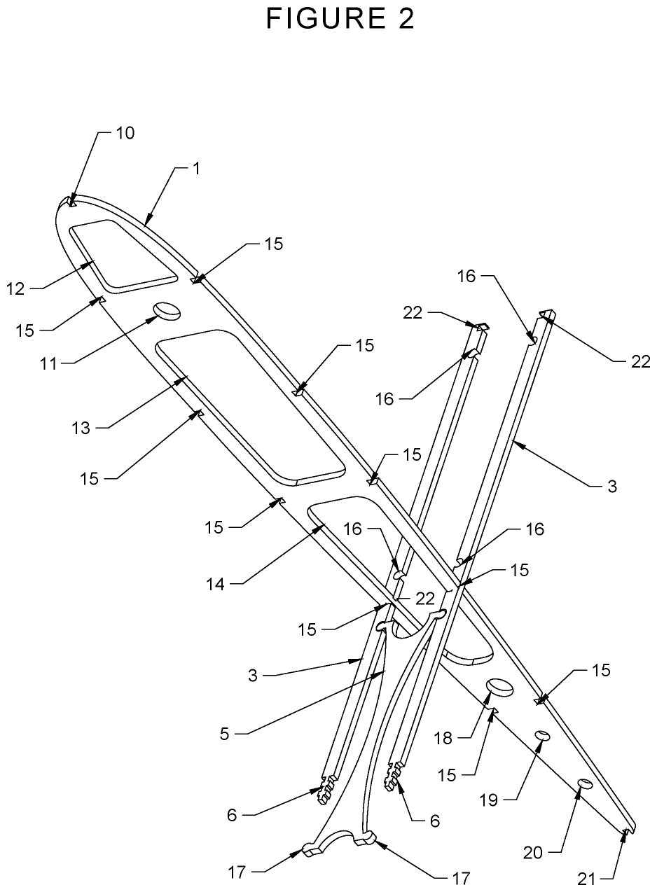

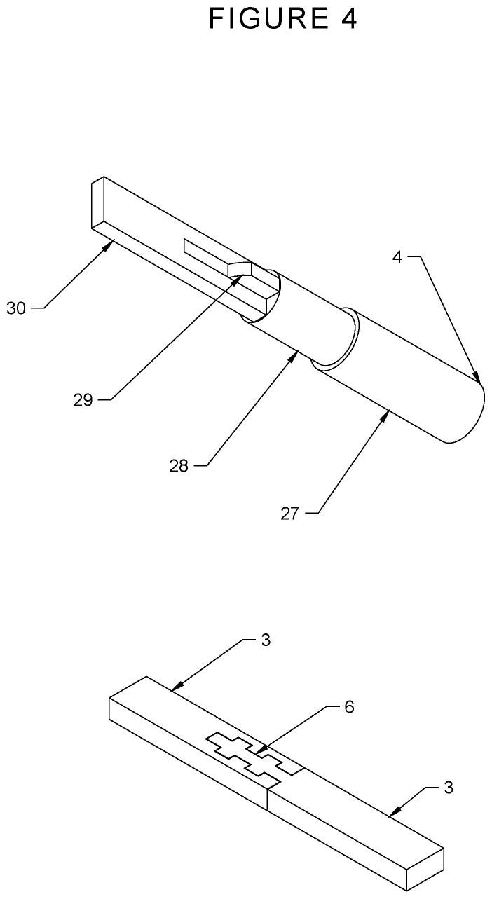

1. The term “circular-dove-tail-locking” as used herein, refers to a pressure fit locking together mechanism in which a circular protruding member fits tightly and snuggly into an existing cutout.
2. The term “pressure fit locking together mechanism’ as used herein, refers to pressure tight enough to join the lock without needing any other assistance like for example glue.
3. The term “light-weight air-foil” as used herein refers to an air foil that is generally lighter in weight than other air foils on the market and in which the inventor's air foil is using thin 5 ply Baltic Birch laminated on both sides with 0.020 inch to 0.040-inch aluminum.
4. The term “laminated rib” as used herein refers to the 5 ply Baltic Birch wood laminated with from 0.020″ to 0.040″ aluminum component member. These are internal components providing structural support and attachment points for other component pieces of the overall frame of the air foil.
5. The term “leading-edge strut” as used herein refers the component that traverses the whole front end of the wing attaching together the multiple ribs of the Air Foil. This leading-edge strut attaches to each of the front notched groove on each multiple rib. The front notched groove on each multiple rib is illustrated in FIG. 2 referenced numbered element 11.
6. The term “Laminated Rib cutaway” as used herein refers a cut out in a laminated rib for the purpose of lightening the overall laminated rib weight and additionally allowing the impregnated foam to flow through to the other ribs within the frame.
7. The term “Predetermined Vertical Axis Wind Turbine Airfoil Internal Component Foil Structure Pieces” as used herein refers all of the Internal Component Frame Structure Pieces making up the Air frame consisting of Laminated Rib, Leading-edge strut, Vertical strut, Alignment Laminated Support Strut, Position four Internal locking circular dove tail support, Trailing Edge laminated Support Strut, the Internal locking circular dove tail supports.
8. The term “Laminated Rib” as used herein refers a plurality of internal supporting structures as shown FIG. 1 numerated number one.
9. The term “Alignment Laminated Support Strut” as used herein refers to the two support internal struts that slide into the Laminated Ribs. The two holes in each laminated Rib are named Forward Laminated Support Rib Hole (number 11) and the trailing laminated support rib hole.
10. The term “Laminated Rib notches” as used herein refers a plurality of rib notches on the edge of the Laminated Ribs.
11. The term “vertical strut locks” used herein refers to an internal component that locks the vertical struts (number 3) together and also assists in holding the placement of the vertical structs that were previously snapped into the laminated ribs (number 1).
12. The term “Double tee Struct Splice” (number 6) used herein refers a connective splice utilizing a pressure fit connection that attaches and lengthens vertical structs as needed. A Double tee Struct Splice is shown in the bottom of FIG. 4.
13. The term “wing” used herein refers to all of the assembled Vertical Axis Wind Turbine Airfoil components.
14. The term “rib chamber sections” used herein refers the gap of span between the individual parallel laminated ribs comprising the overall wing.
15. The term “middle high-density expanding foam portal entry” (number 19) as used herein refers a member that allows for the free flow of high-density foam between rib chamber sections.
16. The term “Trailing high-density expanding foam portal entry” (number 19) as used herein refers a member that allows for the free flow of high-density foam between rib chamber sections.

### PREFERRED EMBODIMENT

The preferred embodiment of this invention is for use on a vertical axis wind turbine.

What is claimed is:

1. A Method of Manufacture for a Vertical Axis Wind Turbine Airfoil, comprising the steps of:
Step 1 is to laminated Baltic Birch 5-layer plywood (number 33) with 0.040″ aluminum on the top and bottom side.
Step 2 the Vertical Axis Wind Turbine Airfoil Internal Component Foil Structure pieces are cut out of the said 0.040 laminated Baltic Birch 5-layer plywood (number 31).
Step 3 Align and slide the laminated ribs (number 1) on the two identical Alignment Laminated Support Struts (number 4) sliding into the Forward Laminated Support Rib Holes (number 11), and Trailing Laminated Support Rib Holes (number 18).
Step 4. The unit consisting of the assembled Laminated Ribs and Alignment Laminated Support Struts from Step 3 will be placed in a horizontal and parallel position to the Assembly Alignment Table (number 44) and the Alignment Laminated Support Struts of the said assembled unit will attached or lay upon the Attachment Member (number 45) of the Assembly Alignment Table (number 44).
Step 5. The Leading-Edge Strut (number 2) is snapped by pressure fitted into the plurality the Leading-Edge Rib Notches (number 10) on each of the Laminated Ribs (number 1).
Step 6. The Vertical Struct Notches (number 22) of the Vertical Struts (number 3) are snapped by pressure fitness into place within the Laminated Rib Notches (number 15).
Step 7. The Trailing-Edge Laminated Support Struts (number 7) are then snapped into the Trailing-Edge Rib Notches (number 21).
Step 8. The Leading-Edge Laminated Support Struts (number 2) are then snapped into the Leading-Edge Rib Notches (number 10).
Step 9. The plurality of Circular Dove Tail Male Connectors (number 17) of the plurality of strut locks (numbers 5, 23,24,25, and 26) are snapped into Vertical Strut Female Connector (number 16) of the Vertical Struts (number 3).
Step 10. The assembly of Step 9 is placed onto a Bottom Protective Teflon Sheet (number 37) which is all set on top of the Base Mold Form (number 36). The Base Mold Form (number 36) is setup and attached by the Aluminum External Mold Supports (number 40) to Mold Support Table (number 35).
Step 11. A Top Protective Teflon Sheet (number 38) is now placed upon the top of the assembled components in Step 10.
Step 12. The Top Mold Form (number 39) is now closed using Hinge (number 43) and is latched and Mold Latching Member (number 41) upon the top of the assembled components from Step 11.
Step 13. High density internal wing foam (number 8) is injected into the cavities of the internal component parts within the mold.
Step 14. Upon the foam curing then completely assembled internal components which are now one bonded unit of fold are remove from the mold and the Teflon sheet is peeled away from the air foil.
Step 15 Air foil is lastly covered with a top coat of carbon fiber.

2. The resulting Vertical Axis Wind Turbine Airfoil produced from the Method of Manufacture for a Vertical Axis Wind Turbine Airfoil as in claim 1.
